(19) United States
(12) Patent Application Publication
(10) Pub. No.: US 2026/0063487 A1
(43) Pub. Date: Mar. 5, 2026

(54) TRIBO-INDUCED CHARGES BASED TENSION SENSING YARNS

(71) Applicant: The Chinese University of Hong Kong, Hong Kong (CN)

(72) Inventors: Kai Yu TONG, Hong Kong (CN); Disheng XIE, Yongji (CN); Yunlong ZI, Guangzhou (CN); Haoyu WANG, Hong Kong (CN); Shuk Fan TONG, Hong Kong (CN); Yujie SU, Hong Kong (CN)

(21) Appl. No.: 18/825,775

(22) Filed: Sep. 5, 2024

(51) Int. Cl. G01L 5/10

(52) U.S. Cl. CPC G01L 5/10

(57) ABSTRACT

A tribo-induced charges based tension sensing yarn (TCTSY) system is provided, including a primary conductive filament having a first dielectric layer coated around an outer surface of the primary conductive filament; and a secondary conductive filament. When outer surfaces of the primary and secondary conductive filaments contact each other, charges are transferred between the contacted outer surfaces of the primary and secondary conductive filaments. When an axial tensile force is applied to the TCTSY system, a potential difference is generated by the transferred charges between the primary conductive filament and the secondary conductive filament, indicating a magnitude of the applied force. The TCTSY system can be integrated into warp and weft yarns of the fabric with weaving pattern, enabling fabric with distributed weft and warp-axial tension sensing where any two crossed TCTSY systems are configured to measure tension distribution over an area around crossed point of the fabric.

### BACKGROUND OF THE INVENTION

Force measurement has evolved from estimating force magnitude based on spring deformation to using strain gauges that measure tiny deformations. Strain gauges are commonly attached to rigid objects, such as S-shaped bodies, to estimate force by measuring their small deformations. Accurate measurements require that the gauges be properly attached to the surface and isolated from interference. Various types of strain gauge have been developed to measure different forces including tension, compression, shear, torque, and more with applications spanning industrial production, robotics, and other fields. Additionally, optical measurement devices, such as Bragg gratings, are widely used to estimate force by analyzing differential strain output.

In the Patent WO2018226162A1, a core-shell nanofibers for capacitive sensing have been proposed. It is a core-shell structure, not the same with the plied yarn structure. Second, it is for sensing of the pressure on the fiber, not the tension on the fiber hence it cannot detect the force on the axial direction and is easily affected by the pressure on radial direction.

In the Patent CN109750403B and Patent CN111277167A, a nanogenerator as a fabric has been proposed. It uses the two types of fibers close and near for generate power, and do not have the core filament.

Further, researchers have turned to biology and biomimetic materials. Golgi tendon organs in the human body, located at the muscle-tendon junction, provide a mechanism for measuring the output force of skeletal muscles. The embedded proprioceptor axons discharge in response to muscle/tendon tension, enabling direct force measurement.

The rise of soft robotics and applications such as exosuits have introduced new challenges in force measurement. The conventional strain gauge approaches can affect output performance and are impractical in constrained environments. Similarly, fragile measurements such as Bragg gratings face difficulties in complex interactive settings. The development of emerging technologies, for example, artificial muscles, underscores the need for innovative measurement methods.

### BRIEF SUMMARY OF THE INVENTION

There continues to be a need in the art for improved designs and techniques for tension sensing yarn system and methods.

According to an embodiment of the subject invention, a tribo-induced charges based tension sensing yarn (TCTSY) system is provided, comprising a primary conductive filament having a first dielectric layer coated around an outer surface of the primary conductive filament; and a secondary conductive filament; wherein when outer surfaces of the primary and secondary conductive filaments contact each other, charges are transferred between the contacted outer surfaces of the primary conductive filament and the secondary conductive filament, and wherein when an axial tensile force is applied to the TCTSY system, a potential difference is generated by the transferred charges between the primary conductive filament and the secondary conductive filament, indicating a magnitude of the applied force. When the TCTSY system is bent or receives the radial press, a lower potential difference is generated compared to the potential difference generated when the axial tensile force is applied. Moreover, the secondary conductive filament has a second dielectric layer wrapped around it. The primary and secondary conductive filaments have different triboelectric series, causing charges transferred between the outer contacted surfaces. The secondary and primary filaments have different triboelectric series, causing charges transferred between the primary filament and secondary filament on both contacted surfaces. Furthermore, the secondary conductive filament is wound around the primary conductive filament in a helix shape with the primary filament being the core filament. Sensitivity of the entire TCTSY system is configured to adjust based on changes of pitch of the secondary conductive filament. When the axial tensile force exerted on the TCTSY system, overall strain of the TCTSY system is within 10%. In addition, the potential difference generated by the axial tensile force exerted on the TCTSY system is quasi-linear. Testing range and sensitivity of the entire yarn are adjusted based on changes of elastic modulus of the core filament. When a pressure is applied to a two-axial tension sensing fabric plane, tension is changed in different areas. Pressure distributions on fabric is obtained by reading output of any two crossed TCTSY systems.

In another embodiment of the subject invention, the TCTSY system aforementioned is integrated into weft yarns of fabric with weaving pattern, enabling fabric with distributed weft-axial tension sensing where one TCTSY system is configured to measure tension distribution over a width of the fabric. Alternatively, the TCTSY system is integrated into warp yarn of fabric with weaving pattern, enabling fabric with distributed warp-axial tension sensing where TCTSY system is configured to measure tension distribution over a width of the fabric. Alternatively, the TCTSY system is integrated into warp and weft yarns of the fabric with weaving pattern, enabling fabric with distributed weft and warp-axial tension sensing where any two crossed TCTSY systems are configured to measure tension distribution over an area around crossed point of the fabric.

In certain embodiments of the subject invention, a tribo-induced charges based tension sensing yarn (TCTSY) system is provided, comprising a dielectric core filament; a primary conductive filament; and a secondary conductive filament; wherein the primary and secondary conductive filaments are wound in a helix shape around the dielectric core filament. When outer surfaces of the primary and secondary conductive filaments contact an outer surface of the dielectric core filament, charges are transferred between the outer surface of the dielectric core filament and the contacted outer surfaces of the primary and second conductive filaments. When an axial tensile force is applied to the TCTSY system, a potential difference is generated by the transferred charges between the dielectric core filament and the primary and secondary conductive filaments, indicating a magnitude of the applied force.

### BRIEF DESCRIPTION OF THE DRAWINGS

FIGS. 1A-1E are schematic diagrams of the tension sensing yarn, wherein FIG. 1A shows the resting and tensioned states of the two-filament configuration TCTSY, FIG. 1B is a schematic diagram showing the working mechanism of the two-filament configuration, FIG. 1C shows the resting and tensioned states of the three-filament configuration TCTSY, FIG. 1D is a schematic diagram showing the working mechanism of the three-filament configuration, and FIG. 1E shows the two-filament configuration is unfolded into a straight wire and a plane, and the sections A-A are shown as well, wherein when the TCTSY is strained, the helical filament indents the core filament, according to an embodiment of the subject invention.

FIG. 2 shows the modelling method and process of the yarn, according to an embodiment of the subject invention.

FIG. 3 shows the mass-production principle using a yarn twisting machine, according to an embodiment of the subject invention.

FIGS. 4A-4I show the characterization results of the tribo-induced charges based tension sensing yarn (TCTSY), wherein FIG. 4A shows that changing the length of the TCTSY changes the output proportionally at the same tension, FIG. 4B shows the model results indicating that the TCTSY output first increases and then decreases as the pitch is increased, which matches the experimental findings, FIG. 4C shows that the hysteresis, range, linearity, and sensitivity testing of four TCTSY configurations reveal low hysteresis between input and output, high linearity, and variable range and sensitivity by adjusting the properties of the core filament, FIG. 4D shows that the TCTSY maintains a frequency-independent output range when loaded from 2 Hz to 8 Hz at the same tension, FIG. 4E shows the lifetime test results indicating that the TCTSY output does not decay after 6000 cycles of loading and unloading, FIG. 4F shows the radar graph of performance metrics for the PTFE-Silver configuration, FIG. 4G shows the radar graph of performance metrics for the PTFE-0.4Nylon-Silver configuration, FIG. 4H shows the radar graph of performance metrics for the PTFE-1.0Nylon-Silver configuration, and FIG. 4I shows the radar graph of performance metrics for the PTFE-PVC configuration, according to an embodiment of the subject invention.

FIG. 5 shows the setup and data for testing output voltage of the tension sensing yarn and the force exerted on the yarn, according to an embodiment of the subject invention.

FIGS. 6A-6H show the comparison between the hysteresis of force-output and force-strain, wherein FIG. 6A shows hysteresis loop between output voltage and input force of PTFE-Silver, FIG. 6B shows hysteresis loop between force and strain of PTFE-Silver, FIG. 6C shows hysteresis loop between output voltage and input force of PTFE-0.4Nylon-Silver, FIG. 6D shows Hysteresis loop between force and strain of PTFE-0.4Nylon-Silver, FIG. 6E shows hysteresis loop between output voltage and input force of PTFE-1.0Nylon-Silver, FIG. 6F shows hysteresis loop between force and strain of PTFE-1.0Nylon-Silver, FIG. 6G shows hysteresis loop between output voltage and input force of PTFE-PVC, and FIG. 6H shows hysteresis loop between force and strain of PTFE-PVC, according to an embodiment of the subject invention.

FIG. 7 shows the setup for testing frequency response and lifetime of TCTSY, according to an embodiment of the subject invention.

FIGS. 8A-8E show the test and data of response to lateral compression, wherein FIG. 8A shows the setup using a linear motor with a glass head to impact the TCTSY, which is fixed on another glass with a force sensor to acquire the force during the impact, FIG. 8B shows the pressing force and corresponding radial response for PTFE-Silver configuration, FIG. 8C shows the pressing force and corresponding radial response for PTFE-0.4Nylon-Silver configuration, FIG. 8D shows the pressing force and corresponding radial response for PTFE-1.0Nylon-Silver configuration, and FIG. 8E shows the pressing force and corresponding radial response for PTFE-PVC configuration, according to an embodiment of the subject invention.

FIGS. 9A-9B show the effect of the pulley on the output of TCTSY, wherein FIG. 9A shows experiment setup for testing TCTSY with pulleys, TCTSY is guided by two pulleys and fixed on the load cell and fixture respectively, and FIG. 9B shows that by changing the diameter of the two pulleys from 15 mm-50 mm, the output difference changes little, according to an embodiment of the subject invention.

FIG. 10 is a schematic representation of the portable measurement circuit to replace the electrometer, according to an embodiment of the subject invention.

FIGS. 11A-11D show the tension sensing yarn applied to artificial muscle, wherein FIG. 11A shows that TCTSYs are wound on the tubes of the artificial muscle to measure the tension from the contraction when the artificial muscle is pressurized, FIG. 11B shows the TCTSY outputs when the pressure in the artificial muscle changes, FIG. 11C shows the load cell outputs when the pressure in the artificial muscle changes, and FIG. 11D shows the pressure changes in the artificial muscle, according to an embodiment of the subject invention.

FIGS. 12A-12B show that the tension sensing yarn is deployed in an artificial muscle-driven elbow exosuit to measure its contraction force on the elbow, FIG. 12A shows that the artificial muscle changes its output force in three levels to drive the elbow to flex in three angles, meanwhile, the TCTSY embedded in the artificial muscle measures the output and also shows three distinct output levels, FIG. 12B shows that the artificial muscle maintains a constant pressure to keep the elbow fixed at a certain angle, then, weights of 200 g and 100 g are added to the hand. The TCTSY output change proportionally, demonstrating adequate sensitivity to achieve proprioceptive sensing for the Golgi tendon organs to detect the changes in load, according to an embodiment of the subject invention.

FIG. 13 shows the tension sensing yarn applied in Mckibben muscle, according to an embodiment of the subject invention.

FIG. 14 shows the tension sensing yarn applied in woven fabric, according to an embodiment of the subject invention.

FIGS. 15A-15E show the testing result from the load cells and output of tension sensing yarn from the woven fabric, wherein FIG. 15A shows the setup for comparing the tension measured by conventional load cells and the tension measured by TCTSYs, four load cells measure the tension of area 1-4 through clamping on the fabrics whereas the TCTSY measures the tension not requiring any hard materials, the data from load cells and TCTSYs when pressing the area 1 (FIG. 15B), area 2 (FIG. 15C), area 3 (FIG. 15D) and area 4 (FIG. 15E), according to an embodiment of the subject invention.

FIGS. 16A-16C show the examples and testing result of the tension sensing yarn applied in scoliosis brace, wherein FIG. 16A shows that TCTSYs are deployed on to a scoliosis brace to correct the unnatural bent spine where four straps sewed with TCTSYs detect the tension on the area, and FIG. 16B shows that the signal from the TCTSY when the air bag is inflated with different pressures, and FIG. 16C shows the pressure in the air bag, according to an embodiment of the subject invention.

FIG. 17 shows the tension sensing yarn applied on the pressure distribution mapping on mattress, according to an embodiment of the subject invention.

FIG. 18 shows the tension sensing yarn applied in on force measurement pants/trousers, according to an embodiment of the subject invention.

FIG. 19 shows the tension sensing yarn applied on the smart touch gloves, according to an embodiment of the subject invention.

### DETAILED DISCLOSURE OF THE INVENTION

The embodiments of subject invention pertain to a tribo-induced charges based tension sensing yarn (TCTSY) system.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

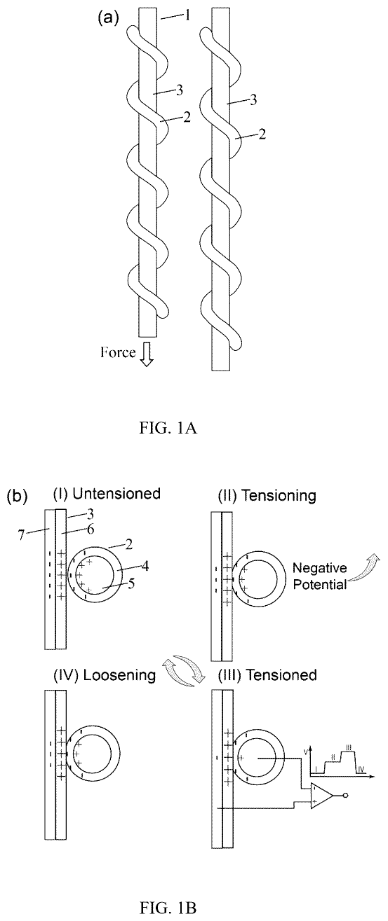

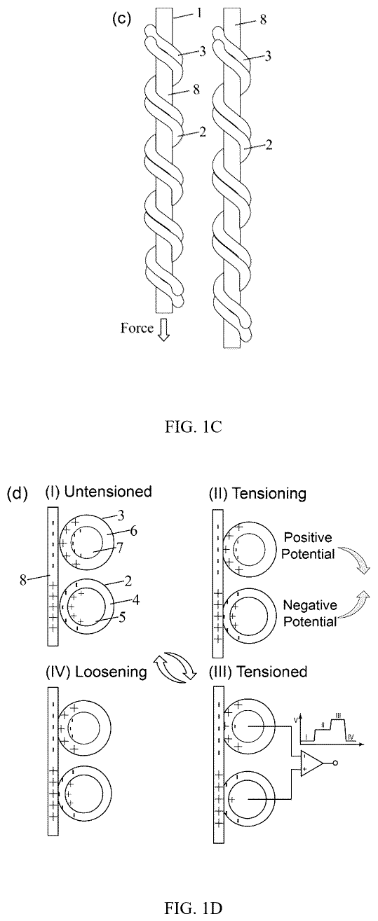

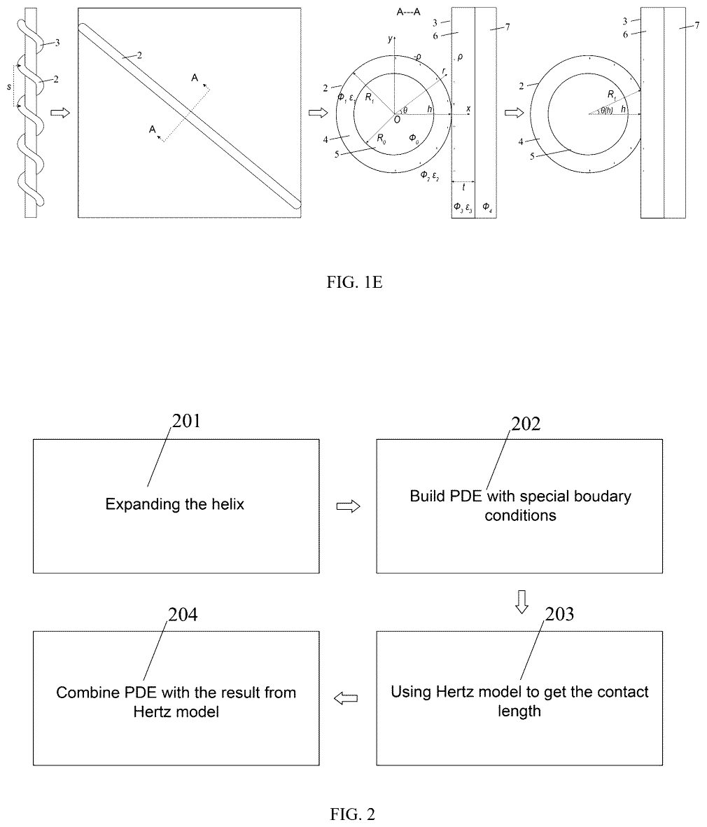

Referring to FIG. 1A, a tribo-induced charges based tension sensing yarn (TCTSY) system 1 comprises two filaments: a positive electrode filament 2 and a negative electrode filament 3, with different dielectric coatings, forming a two-filament configuration. The TCTSY system 1 operates based on the triboelectric effect and electrostatic induction. When the filaments come into contact, charge transfer occurs: the positive filament loses electrons from its outer surface, while the negative filament gains them on its outer surface. In the resting state that is defined as a state in which the force exerted on the yarn is gone and the yarn returns to its initial state, the contact area between the filaments is minimal, resulting in the largest potential difference as shown in FIG. 1B.

When a tensile force is applied, the helical negative filament's center diameter decreases, increasing the contact area between the filaments. Consequently, the distance between the positive and negative charges to the atomic level is reduced and the overall tribo-charge density on the overlapped surface approaches zero. Only the tribo-charges on the non-contact area now induce charges on the inner electrode, decreasing the potential difference. Further tension increases the contact area and reduces the potential difference. Upon unloading, the TCTSY system returns to its original state, and the potential difference is restored. By measuring the voltage output generated, the TCTSY system provides information about magnitudes of the applied force.

Therefore, the small diameter of the fibers and weak output of each winding are overcome by the exponential amplification from the accumulated charges across hundreds of windings, resulting in a noticeable voltage output even when a small force is applied.

The method as shown in FIG. 2 illustrates the cumulative effect as following:

In the step 201, the helix-straight filaments problem is converted into the straight filament-plane problem by expanding the helix filament into straight filament and the core filament into a plane. Then, in the step 202, any cross-section of the expansion result is taken, and a one-dimensional partial differential equation is established, pointing from the center of the cross-sectional circle to the plane through special boundary conditions. Next, in the step 203, starting from the Hertz contact model of the helix and core filaments, the relationship between the unfolded straight filament and the plane, as well as the indentation relationship between the straight filament and the plane, is obtained. Then, in the step 204, the results from the Hertz model and the partial differential equation are combined such that the overall model can be built.

Compared to previous approaches, the TCTSY system measures forces in a different manner. Instead of enhancing sensitivity on a small volume or area, the TCTSY system leverages the cumulative, distributed effect to determine the tension exerted on the threads.

In addition to the two-filament configuration aforementioned, a three-filament configuration is developed for different sensing ranges and sensitivities in various scenarios as shown in FIG. 1C. For example, the positive filament 3 is moved to the outer layer, with the core filament 8 being a pure dielectric for easy lectotype. Triboelectrification now occurs between the core 8 and positive filaments 3, as well as between the core 8 and the negative filaments 2. By varying the core material, the desired range and sensitivity can be achieved for specific applications.

Various embodiments of the subject invention are provided including two two-filament configurations (PTFE-Silver, PTFE-PVC) and two three-filament configurations (PTFE-0.4Nylon-Silver, PTFE-1.0Nylon-Silver), where the names represent the electrode materials and diameter used. Unless explicitly stated, the data presented below is obtained from the PTFE-0.4Nylon-Silver configuration.

Comparison with Existing Technology

According to the embodiments of the subject invention, the TCTSY system of the subject invention has advantages over existing methods, devices, and materials, as no current technology based on filamentous structures can detect the tension exerted on itself.

The subject invention, a yarn system capable of measuring its own tension, holds significant potential for cable-driven, tendon-driven, or yarn-driven apparatus to monitor the tension force.

### Materials and Methods

In one embodiment, for the two-filament configuration of the TCTSY system, the negative filament 2 is a commercial polytetrafluoroethylene (PTFE) coated, silver plated copper wire. PTFE is a dielectric material with a high negative triboelectric series. The positive filament 3 is either a commercial silver/polyester fiber blended filament for the PTFE-Silver configuration, or a commercial polyvinyl chloride (PVC) coated steel wire for the PTFE-PVC configuration.

In another embodiment, for the three-filament configuration of the TCTSY system, the negative filament 2 is also a commercial polytetrafluoroethylene (PTFE) coated, silver plated copper wire. The positive filament 3 is a silver/polyester fiber blended filament, and the core filament 8 is a commercial nylon filament. This configuration is denoted as PTFE-0.4Nylon-Silver or PTFE-1.0Nylon-Silver, where the core nylon has a diameter of 0.4 mm or 1.0 mm, respectively. Aforementioned is an exemplary embodiment. The PTFE filament has a diameter of 0.26 mm. “0.4Nylon” refers to a nylon filament with a diameter of 0.4 mm, whereas “1.0Nylon” refers to a nylon filament with diameter of 1.0 mm. The silver filament has a diameter of 0.1 mm. The diameters can be adjusted to several millimeters depending on the applications. For all TCTSY configurations, the twisted TCTSY is coated with a polyurethane layer for isolation and packaging, thereby providing a stable shape and consistent force-output characteristics.

### Mass Production of TCTSY System

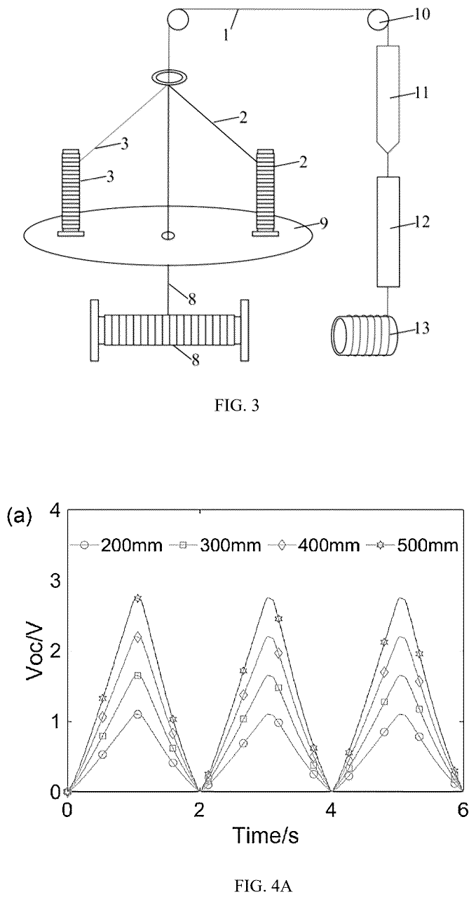

To mass-produce the TCTSY system, a high-speed yarn braiding machine is employed to ensure consistent and stable manufacturing, as depicted in FIG. 3. When the yarn twisting machine operates, the base disk 9 rotates, enabling the negative filament 2 and the positive filament 3 to be woven in the same direction around the core filament 8 for the three-filament configuration. Whereas for the two-filament configuration, the base disk 9 rotates to make negative filament woven on the positive filament. The whole TCTSY system then passes through a guide roller 10 and enters a coating chamber, for example, a TPU glue chamber 11, where it undergoes uniform insulation coating. Subsequently, the fiber proceeds to the heating chamber 12, where the TPU glue is solidified, ensuring its adhesion to the filament. Finally, the fiber is stably wound on the reel by the take-up device 13. By changing the speed ratios between rotations of the base 9 and rotations of the take-up device 13, variable pitch of the TCTSY system can be achieved.

### Key Performance Metrics

To assess performance of the TCTSY system of the subject invention, five key metrics have been defined.

Range: The maximum input force at which the TCTSY system maintains linear output response.

Linearity: The linear correlation coefficient between output voltage and input force at the upper bound of the input range, as defined by the Equation below:

$$Corr ( Input , Output ) = \frac{Cov ( Input , Output )}{stdev ( Input ) stdev ( Output )}$$

where Cov(Input, Output) is the covariance between Input and Output, and stdev(Input) and stdev(Output) are the standard deviations of Input and Output.

Sensitivity: Because the TCTSY system has length-proportional output, the sensitivity must be normalized by length. Hence, the sensitivity is defined as the maximum output within the linear range, divided by the corresponding maximum input force and current length, as defined by the Equation below:

$$Sensitivity = \frac{Output Range}{Range \times Length}$$

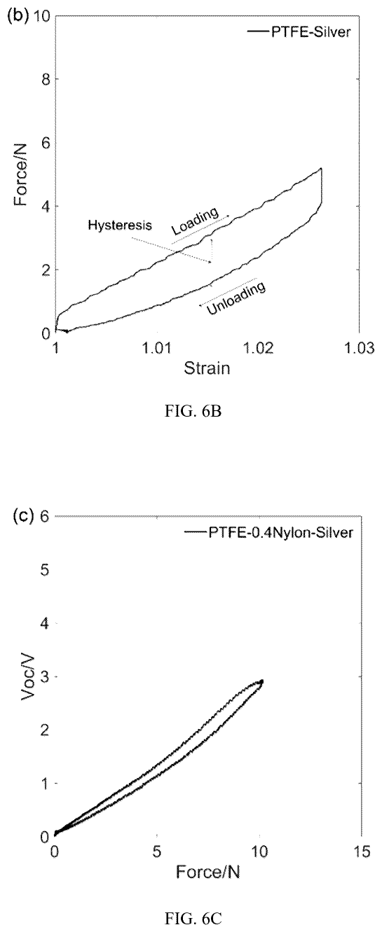

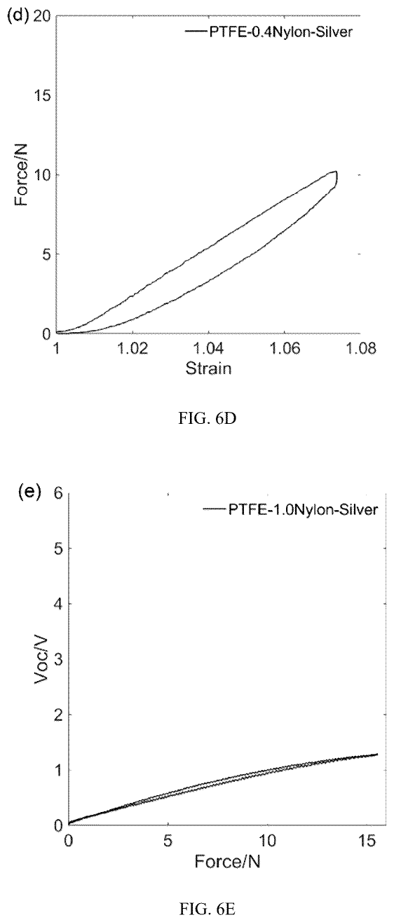

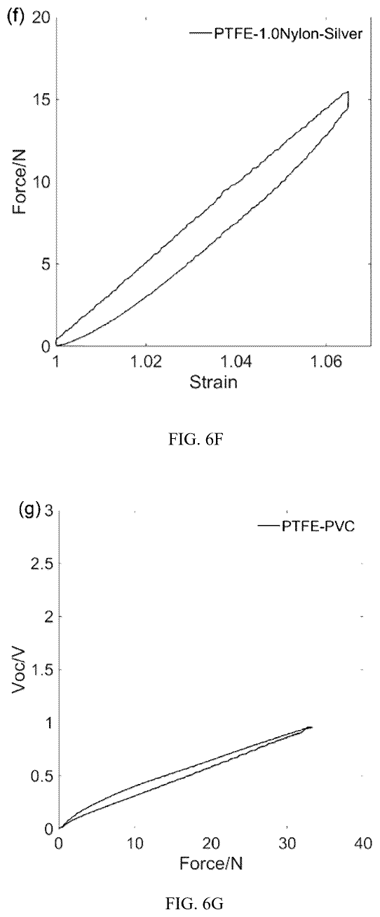

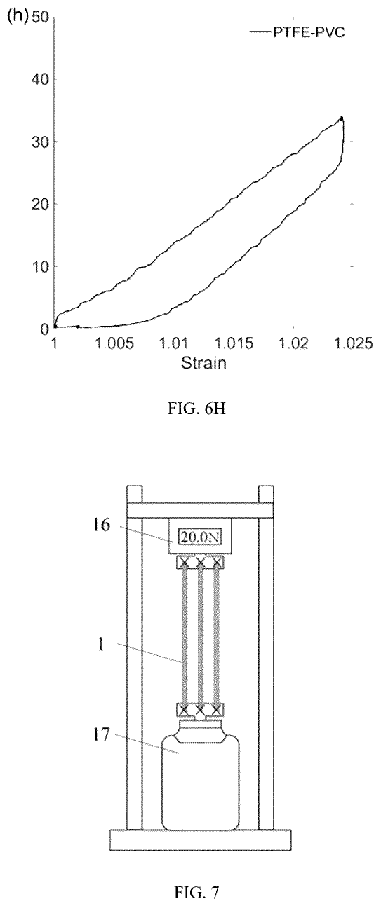

Hysteresis: Hysteresis is defined as the maximum difference in output voltage at the same input force, when tensioned to maximum linear range then unloaded, divided by the maximum output voltage as shown in FIGS. 6A-6H and defined by the Equation below:

$$Hysteresis = \frac{Max ( {Output}_{loading} ( Input ) - {Output}_{unloading} ( Input ) )}{Range}$$

When used in radar graph, the hysteresis is changed to 1-hysteresis to enable the TCTSY system with lower hysteresis or better performance to have higher values.

Robustness: The ratio of maximum linear output per unit length to the radial response per unit length, as defined by the Equations below:

$$Radial sensivity = \frac{Radial response}{Radial press force \times Press length}$$

$$Robustness = \frac{Sensivity}{Radial sensivity}$$

where the Radial response, Radial press force and Press length is defined in FIGS. 6A-6H.

These five metrics are used to form a radar plot, directly assessing the performance of the different TCTSY configurations.

### Characterization

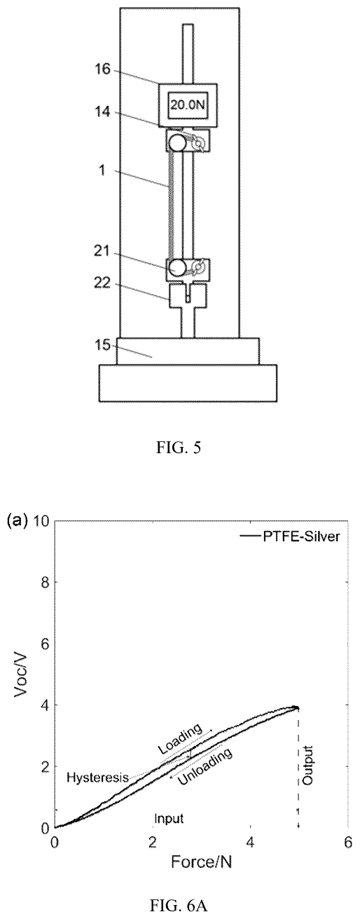

To investigate the output characteristics, metrics, and hysteresis of the TCTSY system, following experimental setup is adopted, as shown in FIG. 5. To minimize the effect of radial pressure, yarn-specific fixtures are used. The TCTSY system is fixed by a clamper, such as rotary knob 14 and through a guide roller 21, then secured on the load cell 16 and fixture 22 of a tensile testing machine 15. The TCTSY system is directly connected to a Keithley 6514 electrometer to acquire its output signal. Keithley 6514 with high input impedance can restore signals with high fidelity. Considering the testing range of the tensile testing machine, the length of the TCTSY system must be much larger than the length pressed by the knob 14 to minimize the interference from press. Thus, the test length is selected as 500 mm. The upper fixture drives the TCTSY Vto be tensioned within the linear region, incrementally increasing the force by 1 N steps until significant nonlinearity is observed. The TCTSY system is then untensioned at a constant speed of 5 mm/min, and this process is repeated 5 times. Simultaneously, the encoder in the tensile testing machine 15 measured the strain of the TCTSY system. This experimental setup allows for simultaneous testing of the range, linearity, sensitivity, and hysteresis of the TCTSY system.

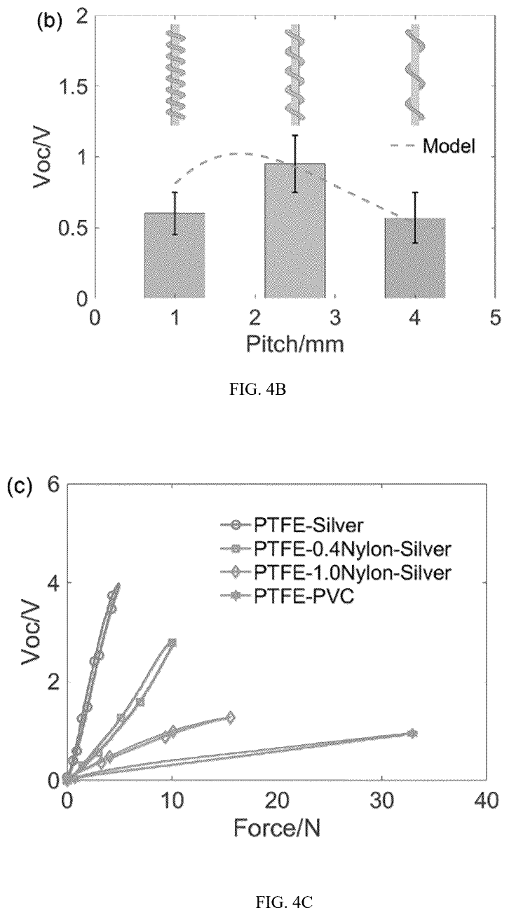

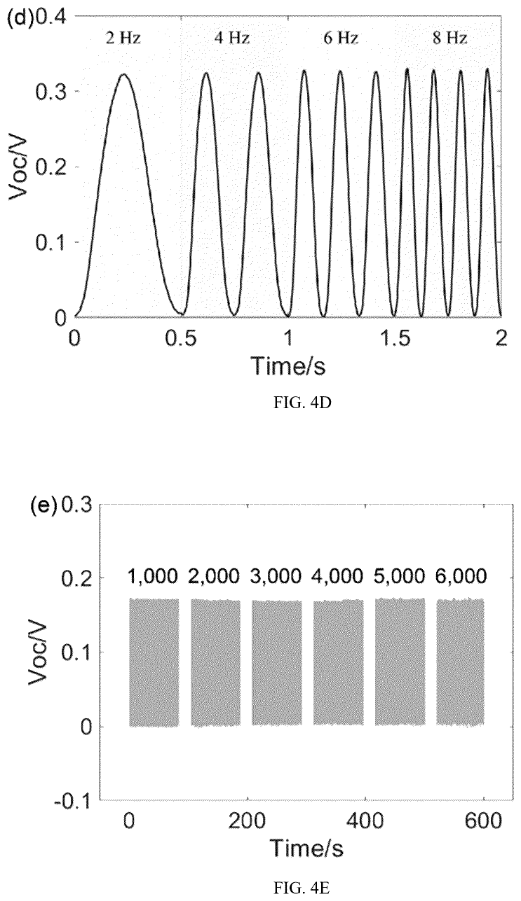

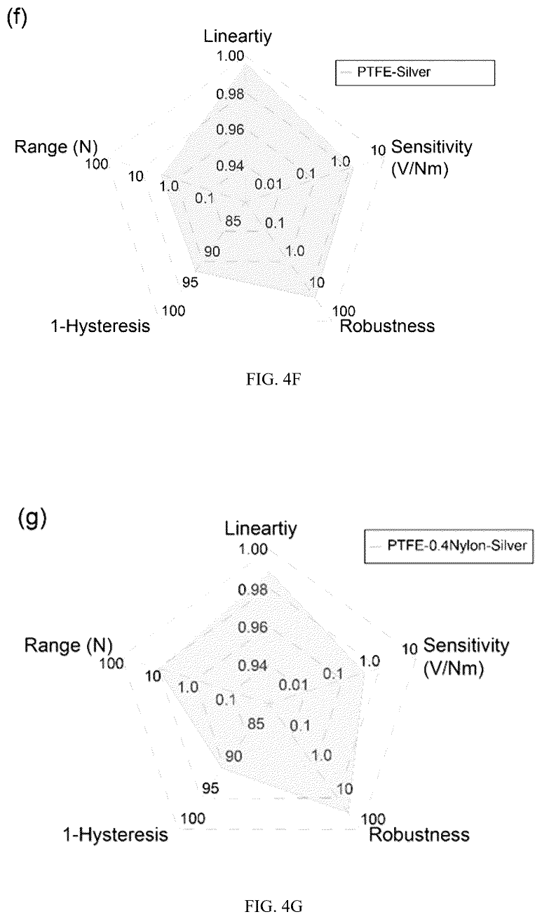

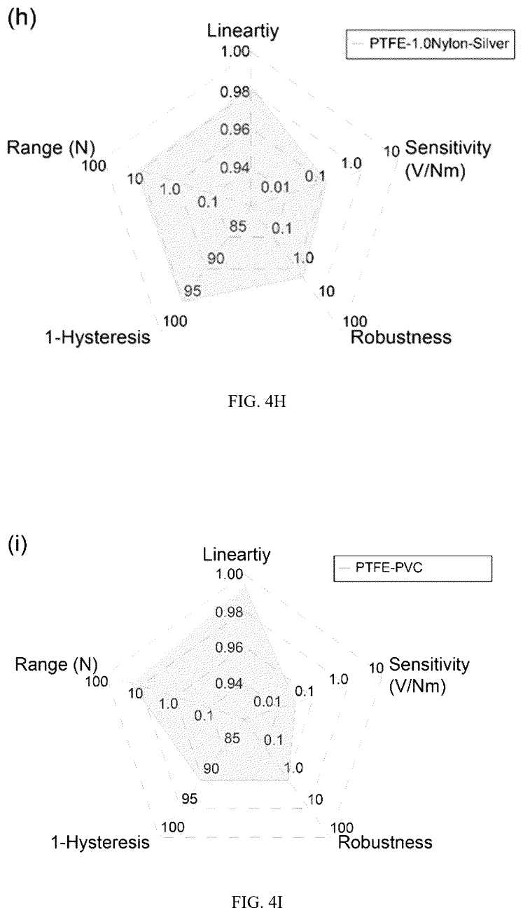

First, the relationship between output voltage and TCTSY system sample length is experimentally investigated. As depicted in FIG. 4A, the TCTSY system shows a quasi-linear relationship between input tension and output voltage the model in Model Section demonstrates the quasi-linear nature of this structure. In FIG. 4A, the output voltage exhibits a linear increase as the TCTSY length is increased from 100 mm to 500 mm under constant tensions, indicating that the output signal or sensitivity has a proportional relationship with TCTSY length, demonstrating the cumulative effect. The model explains the principle of this linear length relationship, as it utilizes the integration of surface charge density to obtain even potential difference per unit length of the cross-section.

Because the TCTSY system comprises a helical filament wound around a core, the helix pitch strongly affects the sensitivity. As shown in FIG. 4B, when the pitch increases from 1 mm to 2 mm, the sensitivity increases. However, the sensitivity then continues to decrease as the pitch is further increased. Samples with three pitches are built with PTFE-0.4Nylon-Silver configuration, and the results match this modeled trend. Increasing the pitch further causes lower sensitivity, because when the pitch increases, the length of the TCTSY system decreases faster than the contraction of the core diameter of the helix. Ultimately, all four configurations are chosen with a 2.5 mm pitch, as it offers a good balance of higher sensitivity and manufacturing efficiency.

Moreover, 500 mm samples with above-mentioned four configurations are tested, and the results are shown in FIG. 4C. All configurations exhibit high linearity, with the PTFE-Silver configuration achieving up to 0.9982 and low hysteresis, with the PTFE-1.0Nylon-Silver configuration reaching as low as 4.6%. The configurations also exhibit varying range and sensitivity, with the PTFE-PVC configuration achieving up to a range of 34 N and the PTFE-Silver configuration achieving sensitivity up to 1.59 V/Nm, as detailed in the radar graph in FIGS. 4F-4I. Increasing the core filament's elastic modulus increases the range but decreases the sensitivity, as can be seen from the gradient and range of the horizontal axis. Notably, the hysteresis is lower than the core filament's, regardless of whether the configuration is a two-filament or a three-filament configuration, as shown in FIGS. 6A-6H. This phenomenon reveals that the hysteresis metric is independent of the core property, enabling the flexible combination of materials for diverse scenarios. In addition, the model reveals that the output is derived from the contact between the helix and core filaments, independent of the core filament's strain.

### Hysteresis Loop

The core filament mainly determines the force-strain relationships of the TCTSY system. However, if the voltage output is directly related to the strain of the TCTSY system, the overall force-voltage relationship will inherit the large hysteresis of the force-strain relationships. Using the same characterization setup as shown in FIG. 5, the hysteresis is investigated. As tested in FIG. 6A, the hysteresis between force-strain of the PTFE-silver configuration is as large as 30%. However, the hysteresis between force-voltage is as low as 5%. The results in FIGS. 6A-6H all show that regardless of the TCTSY configuration, the hysteresis between force-voltage is consistently lower than the hysteresis between force-strain, suggesting that the hysteresis does not relate to the strain, but instead being directly related to the force. The model explains the phenomenon that the TCTSY's output is directly related to the force on the helix. Hence, the hysteresis is attributed to the contact between the helix and the core filament, rather than the overall strain of the TCTSY system.

### Frequency Response and Lifetime Test

The TCTSY system is fixed on a frame in a three-fold configuration as shown in FIG. 7. One end of the fixture is connected to a load cell, while the other end is connected to a vibration generator (for example, ET-126B-04, Labworks Inc.). The same electrometer is used to acquire the TCTSY's output signal. The vibration generator's frequency is switched from 2 Hz to 8 Hz to investigate response of the TCTSY system to the frequency. Additionally, the TCTSY's lifetime is tested on this setup at a fixed frequency of 8 Hz.

FIG. 4D shows results of the frequency response of the TCTSY system. The output range remains constant as the frequency of the vibration exciter is increased up to 8 Hz, demonstrating the TCTSY's suitability for deployment in most force measurement scenarios. Further, the lifetime test for the TCTSY system, conducted using the configuration detailed above and shown in FIG. 4E, demonstrates no output decay even after over 6,000 cycles, highlighting the stability of the configuration.

### Robustness Test

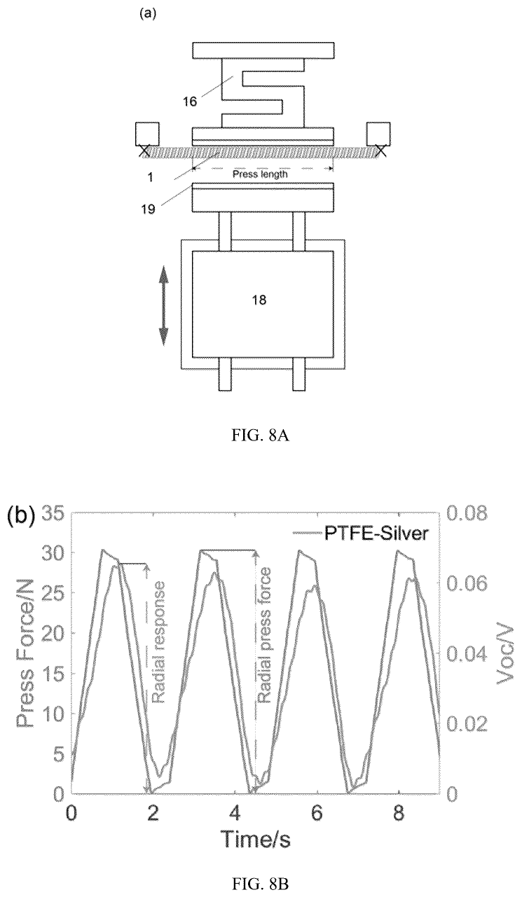

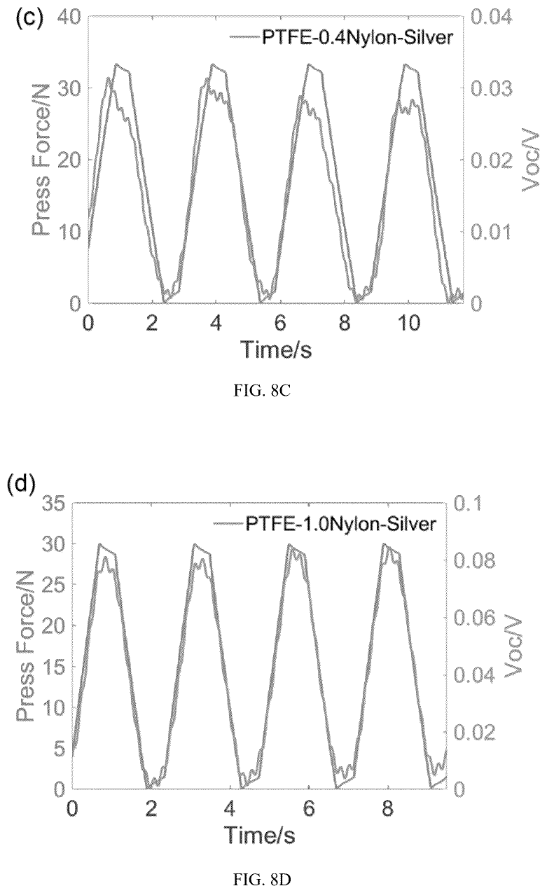

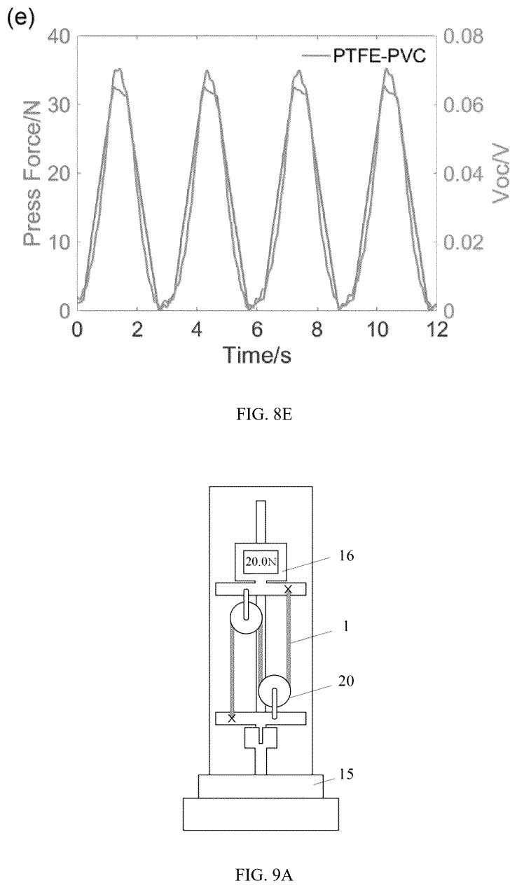

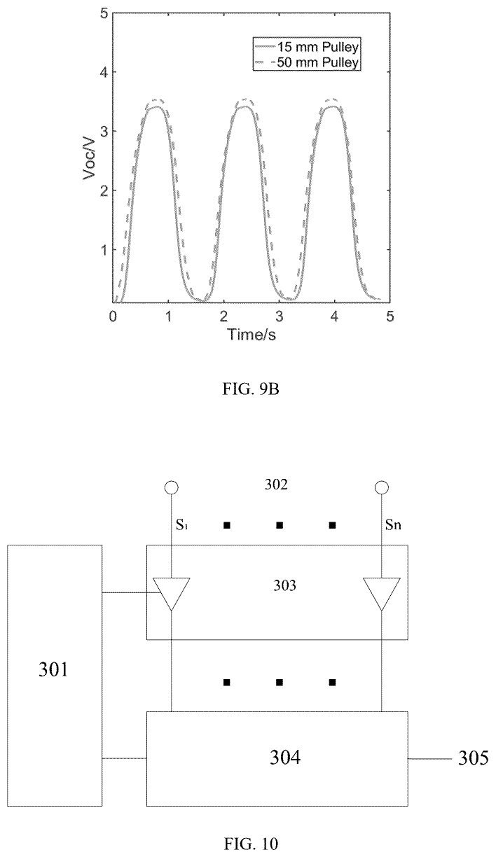

Because the TCTSY system leverages the cumulative, distributed effect to determine the tension exerted on the threads, the radial pressing may affect the output. To obtain the robustness metric defined in Key Performance Metrics section, the four configurations are pressed radially by a linear motor, all showing a linear relationship between the radial pressing force and output voltage, as demonstrated in FIGS. 8A-8E. The results show that for the PTFE-0.4Nylon-Silver configuration, although the pressing force reaches up to 30 N, the output is only 0.028 V per 60 mm, which is low compared to the axial output per force as shown in FIG. 4C. This configuration exhibits the highest robustness, reaching up to 44.2045 as shown in FIGS. 4F-4I. The results also show a trend that the stiffer the core filament is, that is, the higher the elastic modulus it has, the lower the robustness metric is achieved. This is because the axial sensitivity is largely affected by the elastic modulus of the core filament, while the radial sensitivity is not. In practical applications, cables are often guided through pulleys, as in the example of cable-driven parallel robots or exoskeletons. To show the effect of the metrics of robustness, the impact of pulleys on the sensor output is also investigated. The same tension range is applied to the same TCTSY system with PTFE-0.4Nylon-Silver configuration through different pulleys, as illustrated in FIGS. 8A-8E. The results show less than a 3% difference, suggesting that pulleys have a minimal effect on the sensor output, indicating that the TCTSY's robustness to lateral compression, as the special structure of the TCTSY system and guided length, only accounts for a small part of the total length.

### Portable Measurement Circuit

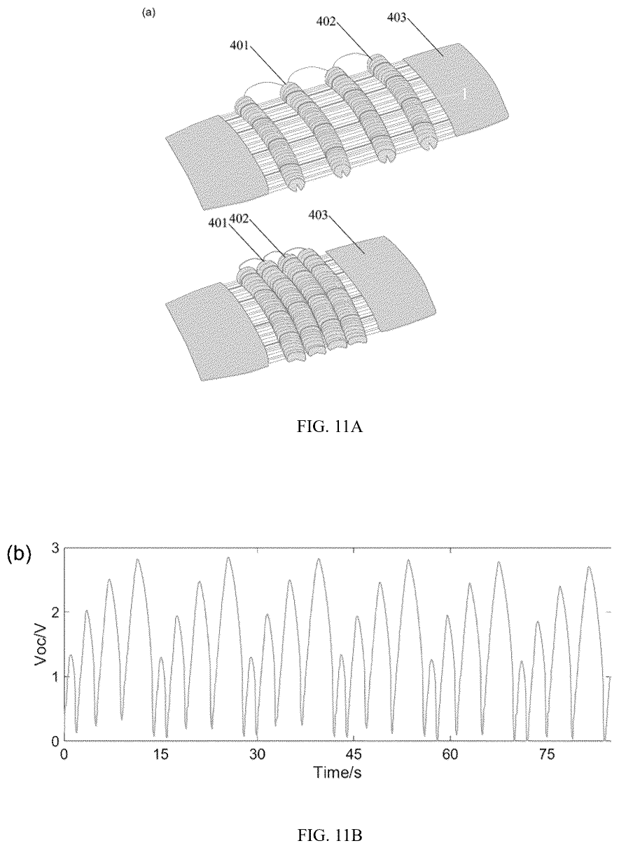

The TCTSY system has a large output impedance, requiring a high-impedance measurement circuit. For the characteristic measurements, an electrometer (for example, >100 T Ω) is used. However, the bulk volume of the electrometer hinders its application in portable scenarios. Therefore, a high-input-impedance instrumentation amplifier >100 G Ω is employed as shown in FIG. 10, which is much higher than the impedance of the TCTSY (for example, >100 M Ω), effectively creating an open-loop circuit. It comprises a low dropout regulator 301 to provide stable voltage to all the components to get a stable measurement. The high-input-impedance instrumentation amplifiers 303 is based on an INA828 chip. The input 302 of the chip is connected with the TCTSY and the output is connected with multi-channel ADC 304 to convert the analog signals to digital signals to be recorded by PC 305. The output of the instrumentation amplifier is then connected to an analog-digital converter (ADC). Since the overall signals are weak, a low-dropout regulator is adopted to supply the amplifier and the ADC to achieve a higher signal-to-noise ratio.

### Applications

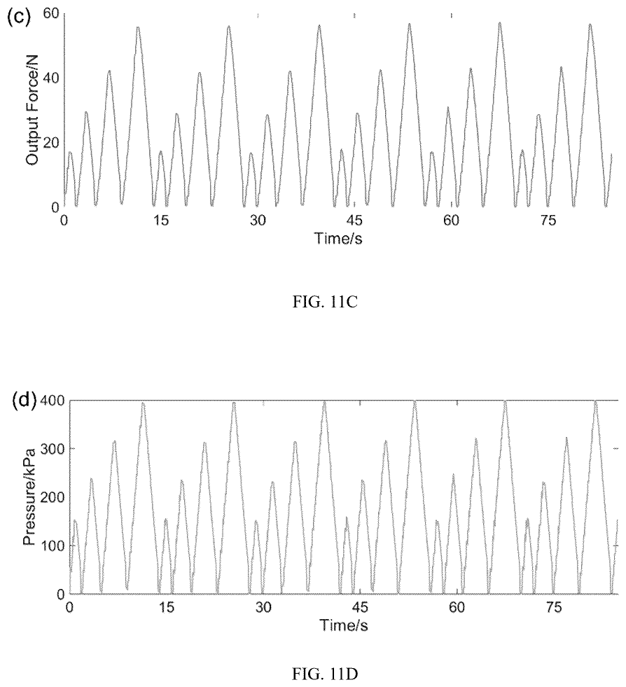

To demonstrate the versatility of the TCTSY system in meeting new application requirements, it is employed in two measurement scenarios. Soft robotics with inherent compliant properties have great potential to accelerate the development of wearable technology, smart clothes and flexible instruments. However, without appropriate tensile force sensing, their large-scale applications are significantly hindered. Wearable exosuits driven by artificial muscles are an important scenario that can assist workers or aid rehabilitation. Measuring the contraction or output force of artificial muscles is a challenging scenario, as the wearable and soft nature of the structure makes it incompatible with traditional measurement approaches. Take an artificial muscle 403 in the Patent U.S. Pat. No. 11,788,562B1 as example, it has fibers 402 wound around several long inflating tubes 401. When the tubes 401 inflate, the fibers are pulled by the tubes and the overall muscle contracts as shown in FIG. 11A. However, because the muscle is flat in shape, it exerts an area force on the anchor region. Hence, measuring its output force is difficult, requiring distributed force measurement methods, especially in a wearable scenario. As shown in FIG. 11A, using the conventional method, measuring the output force of the artificial muscle requires a large fixture and load cell on one side. To meet the demand for force measurement of the artificial muscle, the TCTSY system with PTFE-0.4Nylon-Silver configuration and a 10 N range is selected as the most suitable option, winding it around the tubes of the ExoMuscle every five millimeters. Thus, each part of the TCTSY system can represent the contraction force around a certain width. Due to the linearity of the output, the total output of the TCTSY system is the sum of the output force on the anchor area. Without calibration, by pressurizing the artificial muscle with step pressures as shown in FIG. 11D, the ground truth output force of the artificial muscle is shown in FIG. 11C, and the corresponding output signal of the TCTSY system is shown in FIG. 11B. The correlation R² between the output force and the output signal of the TCTSY system equals 0.9698, demonstrating its viability for measuring the distributed force on the muscles.

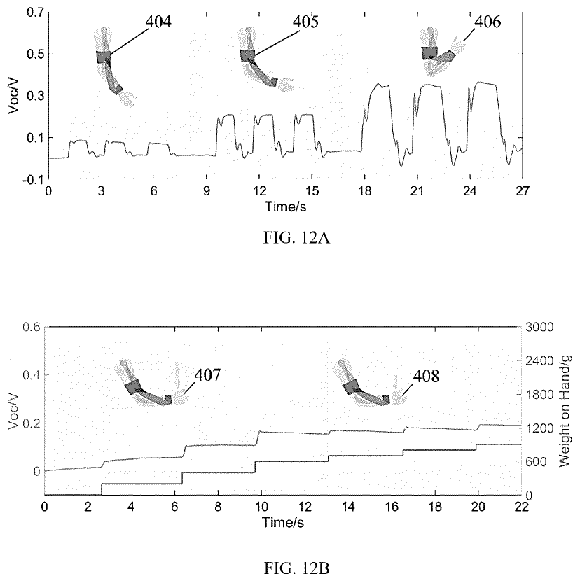

In one embodiment, an elbow exosuit driving elbow flexion is developed and is deployed on an elbow model to inhibit the interference of human active force, ensuring clean results. The same TCTSY system is deployed on the artificial muscles of the elbow exosuit as in the above method. The elbow exosuit mimics the behavior of the brachioradialis. One end is connected to the end of wrist whereas the other end is connected to the upper arm to drive the elbow flexion. As shown in FIGS. 12A and 12B, the elbow flexion is generated from the contraction of the artificial muscle, and extension is achieved by gravity. Three pressure levels are selected to make the artificial muscle generate three different force levels: low flexion 404, mid flexion 405 and high flexion 406, resulting in three different elbow flexion angles. Each of the three pressure levels is repeated three times. The results in FIG. 12A clearly capture the different force levels applied to the model elbow, showing the high repeatability of the TCTSY system. With the elbow exosuit fixed at a constant angle by applying pressures, different weights are placed on the hand of the model one by one, to simulate the same function of the Golgi tendon organs of the skeletal muscle. First, three 200 g weights 407 are placed on the hand, followed by three 100 g weights 408. The increased weight on the hand results in a clear and proportional signal from the TCTSY system as shown in FIG. 12B, demonstrating its effectiveness in endowing the artificial muscle with the same force sensing capability as the skeletal muscle.

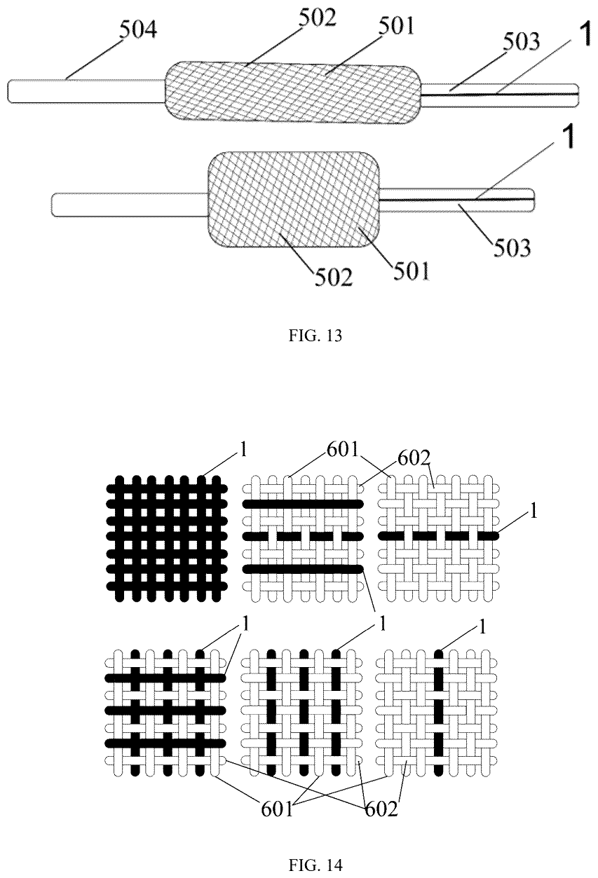

FIG. 13 shows an example of tension sensing yarn system applied to Mckibben muscle 504 to detect the tension of the muscle during contraction. The Mckibben muscle 504 comprises fibers 501 wound around a tube 502, and the two ends are connected with a connector 503. The TCTSY system is connected with the connector 503 in parallel. Hence, when the tube 502 inflates, the overall muscle contracts and the TCTSY system can detect the contraction force of the Mckibben muscle 504.

FIG. 14 shows an example of a typical weaving structure (for example, plain weave) and the tension sensing yarn 1 is integrated into the fabric. The tension sensing yarn 1 can be selectively applied in either the warp 601 or the weft 602 directions, or it can be integrated throughout the entire fabric. Additionally, the number of tension sensing yarns used can be varied, ranging from a single yarn to multiple yarns, depending on the specific application requirements. Apart from the plain weave, the tension sensing yarn system can be applied to other woven structures, for example, twill weave, denim, satin and spacer fabrics.

The integration of variable sensing modalities has enabled smart textiles to serve functions including exercise monitoring, physiological parameter tracking, and numerous other applications. These capabilities are predominantly based on strain sensors that leverage capacitive, resistive, inductive, magnetic or electrostatic measurement principles. However, the incorporation of tensile force sensing has been conspicuously absent from the existing body of research on smart textile systems. This oversight is evident in the limitations of pressure garments, which lack the appropriate tension sensing mechanisms to achieve truly adaptive, intelligent, and safety-conscious performance. The dearth of tension sensing impairs the ability to accurately monitor and dynamically respond to the evolving interactions between the textile structure and the user's body during physical activities.

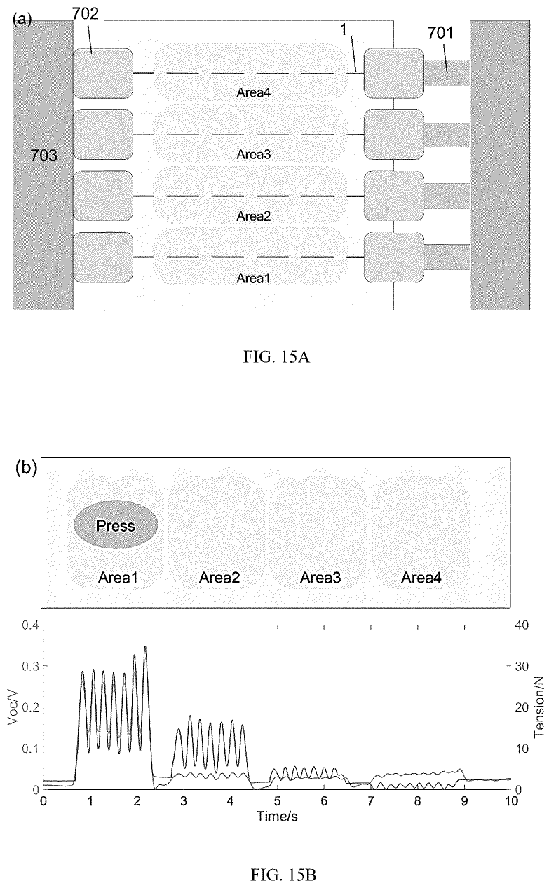

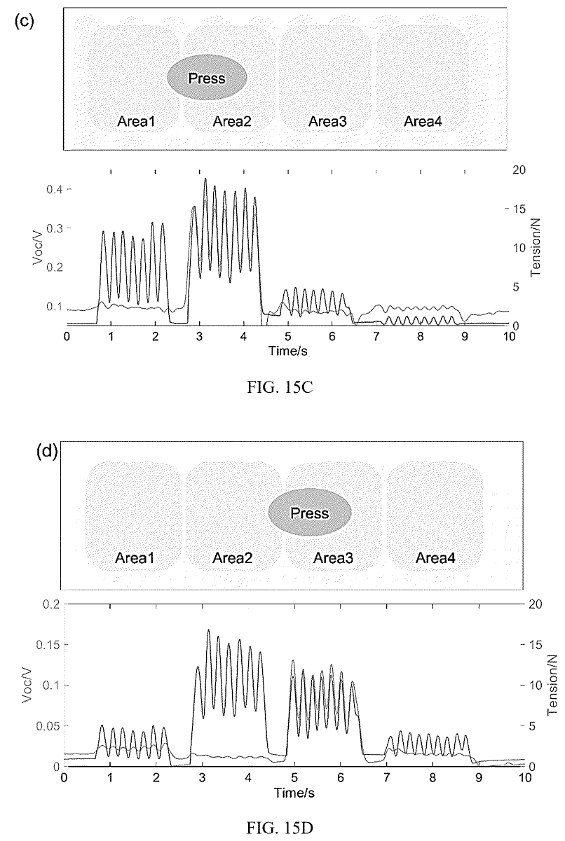

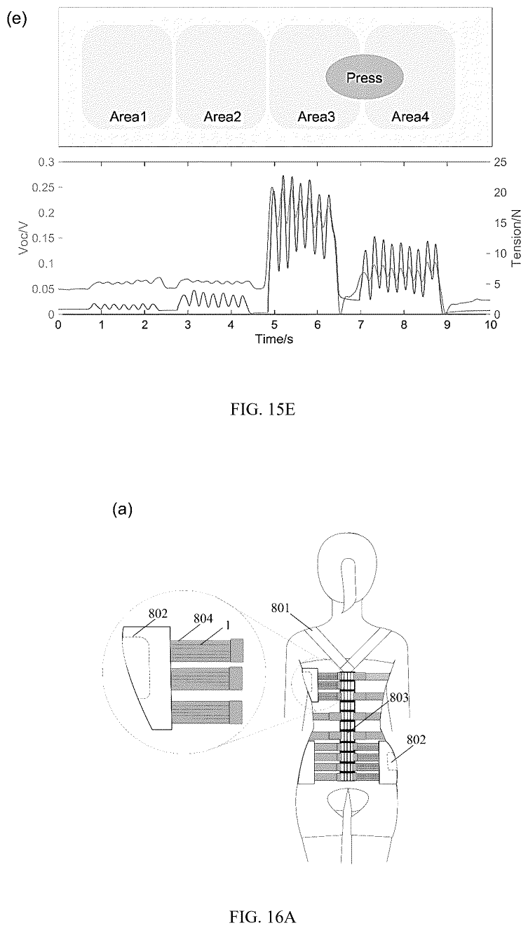

In one embodiment, a fabric with a weaving pattern is developed, incorporating TCTSY system as the weft yarn at 25 mm intervals, as shown in FIG. 14. The distributed tension across the four segmentations of the fabric is measured using four load cells 701 through fixers 702 on base 703, as illustrated in FIG. 15A. The embedded TCTSY system enables the fabric to possess self-tension sensing capabilities. By applying pressures to different areas 1-4, distinct output patterns are observed. Pressing only area 1 caused the TCTSY system in that region to output a signal, while also triggering the force sensor in area 2 to detect gross tension changes resulted from the interactions among the warp and weft yarns as shown in FIG. 15B. Without calibration, the correlation coefficient R2 between the actual tension and the TCTSY output signal is 0.9793, demonstrating the effective tension sensing capabilities of the TCTSY system. Pressing area 2 and part of area 1 caused the TCTSY system in area 2 to output a signal, while the TCTSY in the distant area 1 registers little signal change as shown in FIG. 15C. Similarly, pressing area 3 and part of area 2 produces the same effect. Pressing area 4 and part of area 3 causes the TCTSY system to output signals in both these proximal areas, as the two TCTSY systems in proximity could sense the regional tensions.

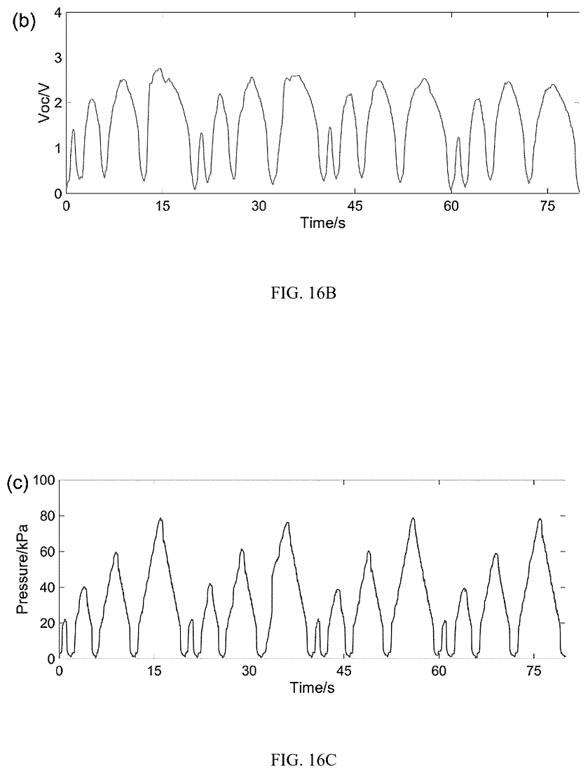

The TCTSY system is then deployed on a scoliosis brace 801 to demonstrate its practical applicability. Soft braces are a conservative treatment option for adolescent idiopathic scoliosis, aiming to replace hard braces and preserve patients' daily activities. The soft braces utilize high modulus elastic textiles with inflatable silicone pads 802 to exert asymmetric corrective forces on the convexity of the apical vertebra, while a flexible hinged artificial backbone 803 sustains the counter forces, as shown in FIG. 16A. While pressures in the inflatable pad 802 acquired from the pressure sensors can represent the forces on the body to evaluate the treatment effects, the interactions between the inflatable pads and tissue during daily activities may change the restraint force or tension on the body. Hence, the pressures must change according to the actual tension. The TCTSY system is therefore deployed in one of the brace straps 804 to directly detect the tension exert on the body. As depicted in FIG. 16C, the pressures in the padding are periodically changed from 20 kPa to 80 kPa. FIG. 16B demonstrates that when the pressures are increased from 20 kPa to 60 kPa, the restraint force or tension force is increased accordingly. However, when increased from 60 kPa to 80 kPa, the restraint force or tension is merely changed, indicating that further increases in the pressure does not change the actual force on the body at that posture. The self-force sensing ability of the TCTSY system enables the development of dynamic braces that can assist patients while minimally limiting their daily activities.

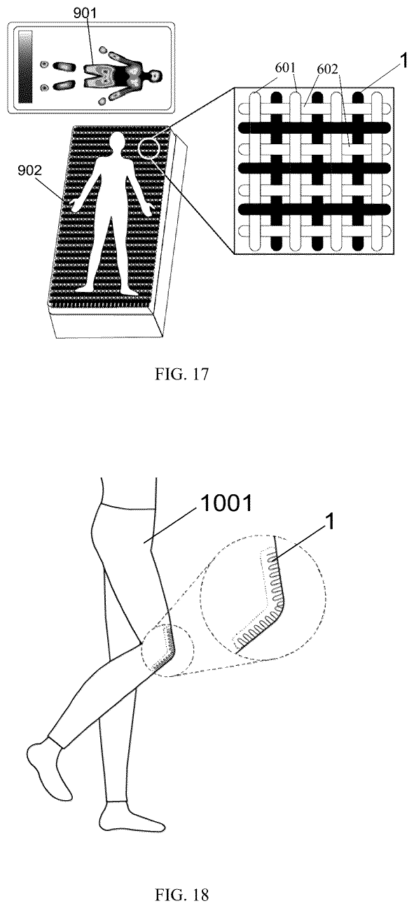

FIG. 17 shows a pressure distribution mapping mattress 902. The tension sensing yarns 1 of the fabric with a weft 601 and warp 602 structure on the top of the mattress can detect the point pressure of the bony parts. Through a pressure sensing system, the pressure distribution mapping 901 can be shown.

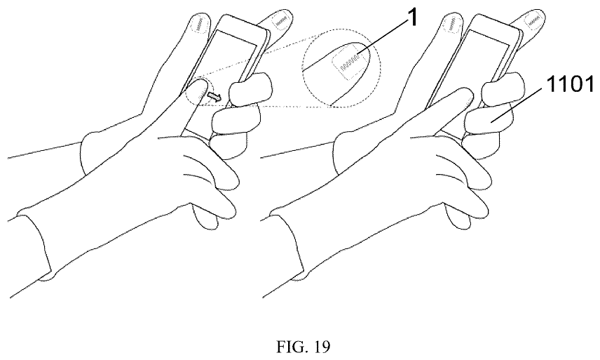

FIG. 18 shows an example of the pants 1001 to detect the knee joint force. The tension sensing yarns 1 integrated on the pants functions as the ligament to measure the joint torque of knee.

FIG. 19 shows an example of the smart touch gloves 1101. The tension sensing yarns 1 integrated on the gloves can measure the pressures applied on the skin. The tension sensing yarn may have some variants based on the method presented above and by combining the different yarn patterns and knitting/weaving structures presented above.

According to embodiments of the subject invention, the tension sensing yarns are configured to utilize the tribo-induced charges to detect tension applied to the yarns. Each yarn comprises three components: a core yarn and two cover yarns twisted closely next to each other in the same direction. The sensing mechanism relies on the accumulation of charge at multiple twists around the core yarn, which amplifies the voltage output of the yarn. The yarn exhibits a linear correlation between the applied tension and the output voltage, making it suitable for a wide range of applications that require precise tension sensing capabilities.

Embodiment 1. A tribo-induced charges based tension sensing yarn (TCTSY) system, comprises a primary conductive filament having a first dielectric layer coated around an outer surface of the primary conductive filament; and a secondary conductive filament; wherein when outer surfaces of the primary and secondary conductive filaments contact each other, charges are transferred between the contacted outer surfaces of the primary conductive filament and the secondary conductive filament, and wherein when an axial tensile force is applied to the TCTSY system, a potential difference is generated by the transferred charges between the primary conductive filament and the secondary conductive filament, indicating a magnitude of the applied force.

Embodiment 2. The TCTSY system of embodiment 1, wherein when the TCTSY system is bent, a lower potential difference is generated compared to the potential difference generated when the axial tensile force is applied.

Embodiment 3. The TCTSY system of embodiment 1, wherein the secondary conductive filament has a second dielectric layer disposed thereon.

Embodiment 4. The TCTSY system of embodiment 1, wherein the primary and secondary conductive filaments have different triboelectric series, causing charges transferred between the outer contacted surfaces.

Embodiment 5. The TCTSY of embodiment 1, wherein the secondary and primary filaments have different triboelectric series, causing charges transferred between the primary filament and secondary filament on both contacted surfaces.

Embodiment 6. The TCTSY system of embodiment 1, wherein the secondary conductive filament is wound around the primary conductive filament in a helix shape with the primary filament being the core filament.

Embodiment 7. The TCTSY system of embodiment 6, wherein sensitivity of the entire TCTSY system is configured to adjust based on changes of pitch of the secondary conductive filament.

Embodiment 8. The TCTSY system of embodiment 1, wherein when the axial tensile force exerted on the TCTSY system, overall strain of the TCTSY system is within 10%.

Embodiment 9. The TCTSY system of embodiment 1, wherein the potential difference generated by the axial tensile force exerted on the TCTSY system is quasi-linear.

Embodiment 10. The TCTSY system of embodiment 1, wherein testing range and sensitivity of the entire yarn are adjusted based on changes of elastic modulus of the core filament.

Embodiment 11. The TCTSY system of embodiment 1, wherein when a pressure is applied to a two-axial tension sensing fabric plane, tension is changed in different areas.

Embodiment 12. The TCTSY system of embodiment 1, wherein pressure distributions on fabric is obtained by reading output of any two crossed TCTSY systems.

Embodiment 13. The TCTSY system of embodiment 1, wherein the primary and secondary filaments are wound in a helical fashion around another dielectric core filament.

Embodiment 14. The TCTSY system of embodiment 13, wherein when outer surfaces of the primary and secondary conductive filaments contact an outer surface of the dielectric core filament, charges are transferred between the outer surface of the dielectric core filament and the contacted outer surfaces of the primary and second conductive filaments.

Embodiment 15. The TCTSY system of embodiment 14, wherein when an axial tensile force is applied to the TCTSY system, a potential difference is generated by the transferred charges between the dielectric core filament and the primary and secondary conductive filaments, indicating a magnitude of the applied force.

Embodiment 16. The TCTSY system of embodiment 1, wherein the TCTSY system is integrated into weft yarns of fabric with weaving pattern, enabling fabric with distributed weft-axial tension sensing where one TCTSY system is configured to measure tension distribution over a width of the fabric.

Embodiment 17. The TCTSY system of embodiment 1, wherein the TCTSY system is integrated into warp yarn of fabric with weaving pattern, enabling fabric with distributed warp-axial tension sensing where TCTSY system is configured to measure tension distribution over a width of the fabric.

Embodiment 18. The TCTSY system of embodiment 1, wherein the TCTSY system is integrated into warp and weft yarns of the fabric with weaving pattern, enabling fabric with distributed weft and warp-axial tension sensing where any two crossed TCTSY systems are configured to measure tension distribution over an area around crossed point of the fabric.

Embodiment 19. The TCTSY system of embodiment 6, wherein the secondary filament is wound around the primary filament in a helix shape with the primary filament being the core filament, and wherein the TCTSY system is fabricated using following system comprising:
a base disk configured to rotate to enable the secondary filament to be woven around the primary filament;
a guide roller;
a coating chamber; and
a take-up device;
wherein the whole TCTSY system passes through the guide roller and enters the coating chamber, where the TCTSY system undergoes uniform insulation coating,
wherein the TCTSY system is stably wound on a reel by the take-up device, and
wherein by changing speed ratios between rotations of the base and rotations of the take-up device, variable pitches of the TCTSY system are achieved.

Embodiment 20. The TCTSY system of embodiment 13, wherein the primary and secondary conductive filament is wound around the dielectric filament in a helix shape, and wherein the TCTSY system is fabricated using following system comprising:
a base disk configured to rotate to enable the primary filament and the secondary filament to be woven in a same direction around the core filament;
a guide roller;
a coating chamber; and
a take-up device;
wherein the whole TCTSY system passes through the guide roller and enters the coating chamber, where the TCTSY system undergoes uniform insulation coating,
wherein the TCTSY system is stably wound on a reel by the take-up device, and
wherein by changing speed ratios between rotations of the base and rotations of the take-up device, variable pitches of the TCTSY system are achieved.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A tribo-induced charges based tension sensing yarn (TCTSY) system, comprises:
a primary conductive filament having a first dielectric layer coated around an outer surface of the primary conductive filament; and
a secondary conductive filament;
wherein when outer surfaces of the primary and secondary conductive filaments contact each other, charges are transferred between the contacted outer surfaces of the primary conductive filament and the secondary conductive filament, and
wherein when an axial tensile force is applied to the TCTSY system, a potential difference is generated by the transferred charges between the primary conductive filament and the secondary conductive filament, indicating a magnitude of the applied force.

2. The TCTSY system as claimed in claim 1, wherein when the TCTSY system is bent or radially pressed, a lower potential difference is generated compared to the potential difference generated when the axial tensile force is applied.

3. The TCTSY system as claimed in claim 1, wherein the secondary conductive filament has a second dielectric layer disposed thereon.

4. The TCTSY system as claimed in claim 1, wherein the primary and secondary conductive filaments have different triboelectric series, causing charges transferred between the outer contacted surfaces.

5. The TCTSY system as claimed in claim 1, wherein the secondary and primary filaments have different triboelectric series, causing charges transferred between the primary filament and secondary filament on both contacted surfaces.

6. The TCTSY system as claimed in claim 1, wherein the secondary conductive filament is wound around the primary conductive filament in a helix shape with the primary filament being the core filament.

7. The TCTSY system as claimed in claim 6, wherein sensitivity of the entire TCTSY system is configured to adjust based on changes of pitch of the secondary conductive filament.

8. The TCTSY system as claimed in claim 1, wherein when the axial tensile force is exerted on the TCTSY system, overall strain of the TCTSY system is within 10%.

9. The TCTSY system as claimed in claim 1, wherein the potential difference generated by the axial tensile force exerted on the TCTSY system is quasi-linear.

10. The TCTSY system as claimed in claim 1, wherein testing range and sensitivity of the entire yarn are adjusted based on changes of elastic modulus of the core filament.

11. The TCTSY system as claimed in claim 1, wherein when a pressure is applied to a two-axial tension sensing fabric plane, tension is changed in different areas.

12. The TCTSY system as claimed in claim 1, wherein pressure distributions on fabric are obtained by reading output of any two crossed TCTSY systems.

13. The TCTSY system as claimed in claim 1, wherein the primary and secondary filaments are wound in a helical fashion around another dielectric core filament.

14. The TCTSY system as claimed in claim 13, wherein when outer surfaces of the primary and secondary conductive filaments contact an outer surface of the dielectric core filament, charges are transferred between the outer surface of the dielectric core filament and the contacted outer surfaces of the primary and second conductive filaments.

15. The TCTSY system as claimed in claim 14, wherein when an axial tensile force is applied to the TCTSY system, a potential difference is generated by the transferred charges between the dielectric core filament and the primary and secondary conductive filaments, indicating a magnitude of the applied force.

16. The TCTSY system as claimed in claim 1, wherein the TCTSY system is integrated into weft yarn of fabric with a weaving pattern, enabling fabric with distributed weft-axial tension sensing where one TCTSY system is configured to measure tension distribution over a width of the fabric.

17. The TCTSY system as claimed in claim 1, wherein the TCTSY system is integrated into warp yarn of fabric with a weaving pattern, enabling fabric with distributed warp-axial tension sensing where TCTSY system is configured to measure tension distribution over a width of the fabric.

18. The TCTSY system as claimed in claim 1, wherein the TCTSY system is integrated into warp and weft yarns of the fabric with a weaving pattern, enabling fabric with distributed weft and warp-axial tension sensing where any two crossed TCTSY systems are configured to measure tension distribution over an area around crossed point of the fabric.

19. The TCTSY system as claimed in claim 6, wherein the secondary filament is wound around the primary filament in a helix shape with the primary filament being the core filament, and wherein the TCTSY system is fabricated using following system comprising:
a base disk configured to rotate to enable the secondary filament to be woven around the primary filament;
a guide roller;
a coating chamber; and
a take-up device;
wherein the whole TCTSY system passes through the guide roller and enters the coating chamber, where the TCTSY system undergoes uniform insulation coating,
wherein the TCTSY system is stably wound on a reel by the take-up device, and
wherein by changing speed ratios between rotations of the base and rotations of the take-up device, variable pitches of the TCTSY system are achieved.

20. The TCTSY system as claimed in claim 13, wherein the primary and secondary conductive filament is wound around the dielectric filament in a helix shape, and wherein the TCTSY system is fabricated using following system comprising:
a base disk configured to rotate to enable the primary filament and the secondary filament to be woven in a same direction around the core filament;
a guide roller;
a coating chamber; and
a take-up device;
wherein the whole TCTSY system passes through the guide roller and enters the coating chamber, where the TCTSY system undergoes uniform insulation coating,
wherein the TCTSY system is stably wound on a reel by the take-up device, and
wherein by changing speed ratios between rotations of the base and rotations of the take-up device, variable pitches of the TCTSY system are achieved.
